(19) United States
(12) Patent Application Publication
(10) Pub. No.: US 2011/0013691 A1
(43) Pub. Date: Jan. 20, 2011

(54) METHOD AND APPARATUS TO GENERATE DIFFERENTIAL SKEW EFFECT ON TRANSITION MINIMIZED DIFFERENTIAL SIGNALING SIGNALS

(75) Inventor: Ramachandra C V, Bangalore (IN)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(73) Assignee: TEKTRONIX, INC., Beaverton, OR (US)

(21) Appl. No.: 12/818,726

(22) Filed: Jun. 18, 2010

(30) Foreign Application Priority Data
Jul. 17, 2009 (IN) 1661/MUM/2009

(51) Int. Cl. H04N 11/02

(52) U.S. Cl. 375/240.01; 375/E07.026

(57) ABSTRACT

A system and method to generate differential skew effect on Transition Minimized Differential Signaling (TMDS) signals for high definition multimedia interface standard (HDMI) using arbitrary waveform generators is described.

### FIELD OF THE INVENTION

The present invention relates generally to signal generation and processing.

### BACKGROUND OF THE INVENTION

Transition Minimized Differential Signaling (TMDS) is an encoding scheme used by the High Definition Multimedia Interface standard (HDMI) for digital audio/video transmission over the HDMI. The TMDS is designed to optimize a clock recovery at a sink, to achieve high skew tolerance.

An intra-pair skew refers to a skew between the TMDS pair (differential signal). An excessive intra-pair skew may result in erroneous signal recovery at the sink. The intra-pair skew measurement is performed to verify that a sink device under test (DUT), such as a display unit in case of the HDMI or DVI, supports the maximum allowable intra-pair skews between the TMDS differential pair.

The HDMI requires compliance to standards defined which need the designers to consider the skew effects.

The existing systems for testing such effects required precise delay settings down to sub-picoseconds resolution. A traditional method of differential skew introduction is done using a hardware solution using the delay lines. One of the single-ended lanes of the differential lanes, that is signal, is passed though hardware delay lines and then added with the other single-ended lane to create skew effects.

The HDMI Compliance Test Specification (CTS) (Ref: HDMI CTS v1.3b—test 8-6) specifies that the sink DUT should support an intra-pair skew up to (0.4 * Tbit) of the differential TMDS signal, for any pixel frequency.

These tests are done for the maximum sink supported frequency.

The procedure for performing the intra-pair skew measurement is as follows:
Vary the intra-pair skew for a channel from 0 to 0.6 * Tbit (=one tenth of the pixel time), or 1 ns whichever occurs first, in steps of 0.1 * Tbit or less.
For Pixel rate equal to or less than 222.75 MHz, if the sink DUT fails for intra-pair skew less than 0.4, then FAIL, for Pixel rate larger than 222.75 MHz, if the sink DUT fails for skew less than 112 ps+0.15 * Tbit, then FAIL.
The same procedure is repeated by varying the skew in the opposite direction.
Transition time converter (TTC) rise time filters should be used at the channel outputs so as to adjust the rise times of the channel outputs within the range 75 ps to 110 ps.
Channel outputs from an arbitrary waveform generator (AWG) must be pulled up to have a common mode voltage of 3.05 V.
Repeat the test but add the skew in the opposite direction
Repeat the test for each of the remaining untested pairs.

The existing methods, however, have limitations with respect to the amount of differential skew that could be produced. This was specifically due to the hardware nature of such solutions.

There is therefore a need of a system and method to generate differential skew effect on the Transition Minimized Differential Signaling (TMDS) signals for the high definition multimedia interface standard (HDMI) using the arbitrary waveform generators (AWG).

### SUMMARY OF THE INVENTION

The invention is to produce differential skew effect on the Transition Minimized Differential Signaling (TMDS) signals for the high definition multimedia interface standard (HDMI).

In one embodiment herein, a user defined TMDS data pattern/input bit stream waveform file is up sampled and a Finite Impulse Response (FIR) “Skew” filter is designed. A coefficients array of the filter is initialized and the up-sampled data is convolved with the coefficients array to create the differential skew effect. Wherein length of the coefficient arrays may be calculated by rounding the value of the product of Samples Per Unit Interval (SPUI=sampling frequency/data rate) and ceiled value of “Skew”.

In one embodiment herein, the filter design may be controlled by a parameter a which is the product of SPUI and the amount of Skew in terms of Tbit.

In one embodiment herein, the generated filtered data may be loaded onto the waveform generator to build a system for creating the Skew effect.

In an embodiment herein, a system is provided for producing differential skew effect on the Transition Minimized Differential Signaling (TMDS) signals for high definition multimedia interface standard (HDMI). The system comprises a differential transmitter for transmitting differential signal on a dual signal path wherein the two signals are driven as a complementary pair with one signal the logical inverse of the other; a differential receiver for receiving resultant signal due to the skew of the two transmitter signals; and a decoder for decoding the resultant signal at the receiver.

Other objects, features and advantages of the invention will be apparent from the drawings, and from the detailed description that follows below.

### BRIEF DESCRIPTION OF THE DRAWINGS

FIG. 1 shows, as per one embodiment of the present invention, the method for producing the differential skew effect.

FIG. 2 shows the differential channel transmitter, channel and receiver system set up for understanding the present invention.

FIG. 3 shows a differential interconnect signal in the experimental set up for understanding the present invention.

FIG. 4 shows resultant signal at a differential receiver in the experimental set up for understanding the present invention.

FIG. 5 shows a differential interconnect signal with skew in the experimental set up for understanding the present invention.

FIG. 6 shows resultant signal with skew at the receiver in the experimental set up for understanding the present invention.

FIG. 7 shows the differential signal carried by two lanes in the experimental set up for understanding the present invention.

FIG. 8 shows the resultant differential receiver signal of the case shown in FIG. 7 in the experimental set up for understanding the present invention.

### DETAILED DESCRIPTION OF THE PREFERRED EMBODIMENTS

The invention described herein is explained using specific exemplary details for better understanding. However, the invention disclosed can be understood and practiced by a person skilled in the art without the use of these specific details. The invention can be implemented into various types of test systems.

A system and method to generate differential skew effect on the Transition Minimized Differential Signaling (TMDS) signals for the High Definition Multimedia Interface standard (HDMI) using arbitrary waveform generators (AWG) is described.

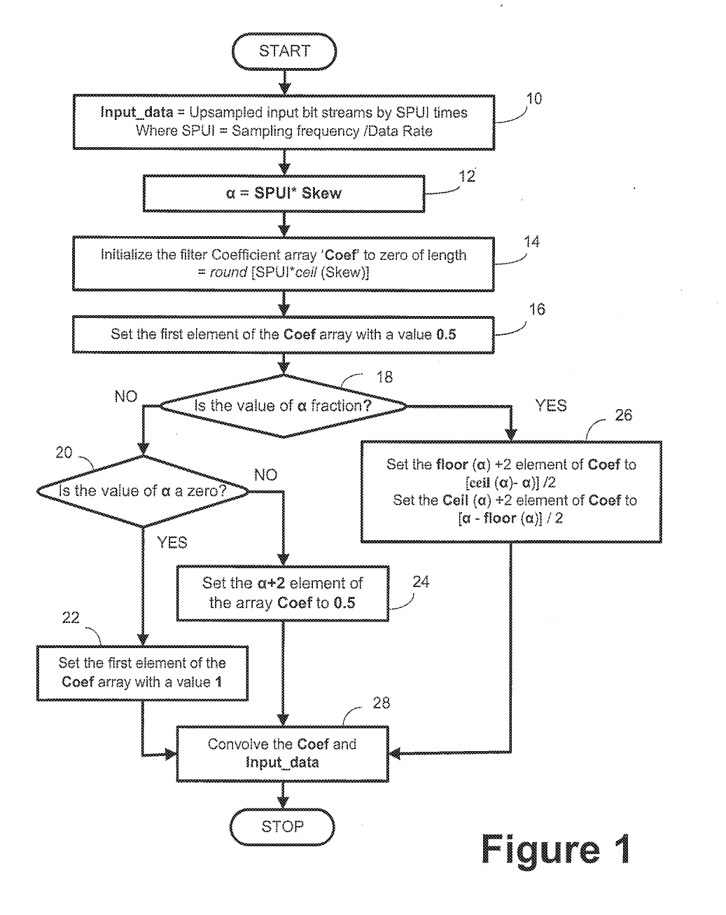

As per one embodiment of the present invention, the method for producing the differential skew effect is as shown in FIG. 1.

The method involves first up-sampling the user defined TMDS data pattern/input bit stream waveform file (step 10). If the ratio is a fraction, then liner interpolation up-sampling technique may be used for up-sampling the data.

A further step 12 involves designing of the FIR Skew filter. The filter design is controlled by a parameter a which is the product of Samples Per Unit Interval (SPUI=sampling frequency/data rate) and the amount of Skew in terms of Tbit (=one tenth of the pixel time).

A further step 14 involves initializing the filter coefficients array (here after referred as “Coef” array). The length of the array is calculated by rounding the value of the product of SPUI and ceiled value of Skew.

In one embodiment the first value of the Coef Array is then set to 0.5 (step 16). Further processing may be divided in three different parts. The first cases is when α is zero (No at a step 18 and Yes at a step 20). The second case is when a is a fraction (Yes at the step 18) and the last is the case of a value is integer (No at the step 18 and No at the step 20). If α value is zero (Yes at the step 20), then set the first array value of Coef to 1 (step 22). If α value is an integer (No at the step 20), then α+2 array element of Coef Array is set to 0.5 (step 24). If the α value is a fraction (Yes at the step 18), then the floor (α) +2th element of Coef Array is set to [ceil (α)−α)] /2 and the Ceil (α)+2th element of Coef is set to [α−floor (α)] /2 (step 26). Rounding is a mathematical operation which when applied on fraction number, rounds it to the nearest integer. Ciel is a mathematical operation which rounds the fraction number towards plus infinity. Floor is a mathematical operation which rounds the fraction number towards minus infinity. For example, round (4.6) is equal to 5 and round of 4.4 is equal to 4. Ceil (4.2) is 5 and ceil (4.6) is also 5. Floor (3.9) is also 3 and Floor (3.1) is also 3.

This up-sampled data is then convolved with the said Coef array to create the differential skew effect (step 28). In one embodiment of the present invention, this synthesized filtered data may be loaded onto the waveform generator to build the system for creating the Skew effect.

The working of the present invention would be explained with reference to following experiment.

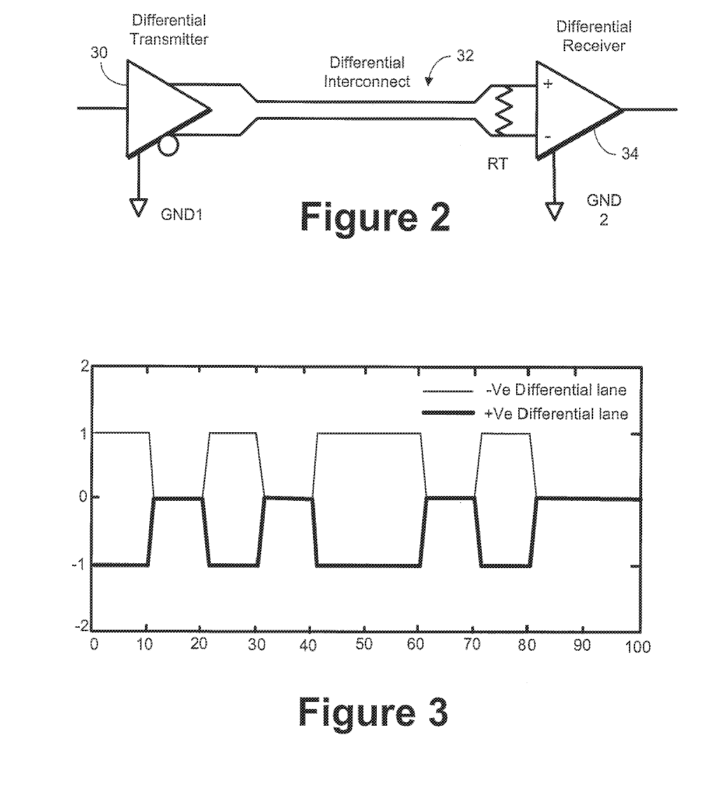

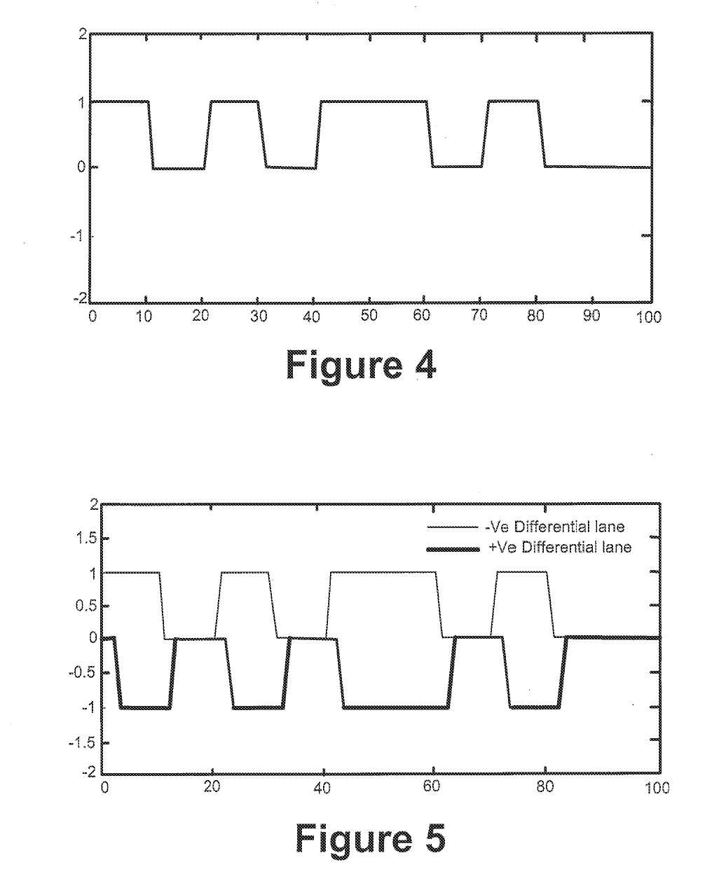

FIG. 2 shows the differential channel transmitter, channel and receiver system. A differential transmitter 30 signal is transmitted on a dual signal path 32 and the two signals are driven as a complementary pair with one signal the logical inverse of the other as shown in FIG. 3 and the resultant signal at the differential receiver is shown in FIG. 4.

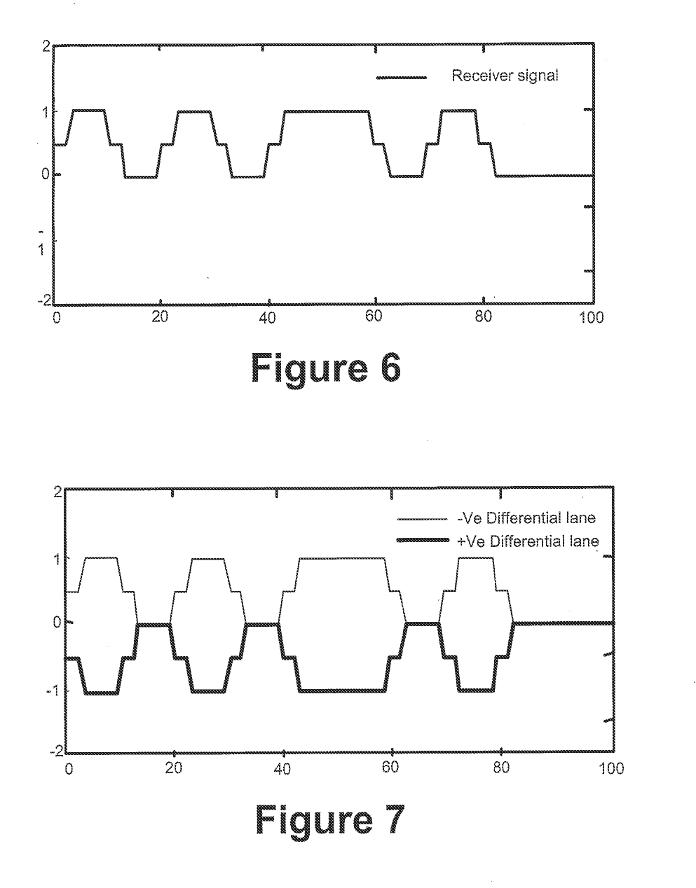

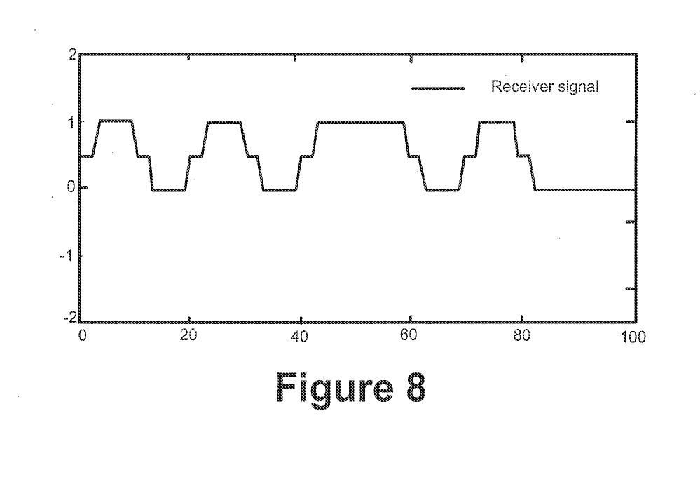

At the receiver 34, the information is decoded using the circuit shown in FIG. 2. FIG. 5 shows the case where there is 30% skew between the two lanes of the channels. The resultant signal at the differential channel due to the skew would be as shown in FIG. 6. The two lanes of the differential lanes will carry the information as shown in FIG. 7. The resultant differential receiver signal is shown in FIG. 8.

When FIG. 6 and FIG. 8 are compared we find that the final output signal at the receiver end using both these methods has the same effects.

The creation of a filter as provided in one embodiment of the present invention, which could directly generate the resultant effect of the skew at the receiver end may be seen through the above experiment.

As may be seen from the experimental set up above the present invention allows a system to generate differential skew and there is no limitation on the amount of differential skew required. Further the embodiments of the present invention may be configured on a waveform generator while providing easier use.

The foregoing description of the invention has been described for purposes of clarity and understanding. It is not intended to limit the invention to the precise form disclosed. The subject invention is intended to be limited only by the following claims.

I claim:

1. A method for producing differential skew effect on Transition Minimized Differential Signaling (TMDS) signals for high definition multimedia interface standard (HDMI); the method comprising the steps of:
up-sampling user defined TMDS data pattern/input bit stream waveform file;
designing FIR Skew filter;
initializing coefficients array of the filter; and
convolving the up-sampled data with the said coefficients array to create the differential skew effect.

2. The method as in claim 1 wherein the filter design is controlled by a parameter a which is the product of SPUI and the amount of Skew in terms of Tbit.

3. The method as in claim 1 wherein length of the coefficient arrays is calculated by rounding the value of the product of SPUI and ceiled value of Skew.

4. The method as in claim 1 wherein the first value of the Coef Array is set to 0.5.

5. The method as in claim 1 wherein value of a in first case is zero, in second case is a fraction and in last case is an integer.

6. The method as in claim 5, if a value is zero, then the first array value of Coef is set to 1.

7. The method as in claim 5, if a value is a fraction ,then the floor (α)+2 th element of Coefficient Array is set to [ceil (α)−α)] /2 and the Ceil (α)+2 th element of Coef is set to [α−floor (α)] / 2 .

8. The method as in claim 5, if a value is an integer then α+2 array element of Coef Array is set to 0.5.

9. The method as in claim 1 wherein the generated filtered data may be loaded onto the waveform generator to build a system for creating the Skew effect.

10. A system for producing differential skew effect on Transition Minimized Differential Signaling (TMDS) signals for high definition multimedia interface standard (HDMI); the system comprising:
a differential transmitter for transmitting differential signal on a dual signal path; the two signals are driven as a complementary pair with one signal the logical inverse of the other;
a differential receiver for receiving resultant signal due to the skew of the two transmitter signals;
a decoder for decoding the resultant signal at the receiver.
